(19) United States
(12) Patent Application Publication
(10) Pub. No.: US 2003/0005302 A1
(43) Pub. Date: Jan. 2, 2003

(54) Theft resistant graphics

(76) Inventor: Scott Searle, Kirkland, WA (US)

Correspondence Address: Patrick J.S. Inouye, The Law Offices of Patrick J.S. Inouye, 810 3rd Avenue, Suite 258, Seattle, WA, 98104, US

(21) Appl. No.: 10/086,493

(22) Filed: Mar. 1, 2002

Related U.S. Application Data
(60) Provisional application No. 60/273,310, filed on Mar. 2, 2001.
(60) Provisional application No. 60/273,456, filed on Mar. 5, 2001.

(51) Int. Cl. H04L 9/00

(52) U.S. Cl. 713/176

(57) ABSTRACT

The addition of personally valuable information to graphical content to reduce theft of the content is disclosed. The showing of the personally valuable information within the content deters users from disseminating the content. The information may be a credit card number of the user, address information of the user, or another type of personally valuable information.

### CROSS-REFERENCE TO RELATED APPLICATIONS

The present application claims the benefit of United States Provisional Patent Application Nos. 60/273,310 filed Mar. 2, 2001, and No. 60/273,456 filed Mar. 5, 2001, and the disclosure of each such application is hereby incorporated by reference.

### BACKGROUND OF THE INVENTION

A burgeoning technology area that is predicted to become even more popular is the display of texts using computers and specialized devices, in lieu of reading the texts from paper. These texts are commonly known as electronic books, or e-books, although their subject matter can also include newspapers, magazines, and other types of texts. Sometimes computers, personal-digital assistant (PDA) devices, and other types of general-purpose devices are used to display a text. Other times, a specialized device, usually referred to as an electronic book reader, is used.

Generally, a text is displayed on the screen of a device for reading by a user in a graphical manner. This means that a part of the text is usually converted to a bit map or other graphical representation of the text. A graphical representation is one in which the computer or other device does not understand what is being displayed as text, but rather interprets it as a graphic, or an image. For example, to the computer, the graphical representation of text is no different than any other type of graphic, such as a logo, an icon, and so on.

A concern of publishers in allowing their books and other text-oriented media to be distributed electronically is the potential theft of the texts. Piracy can be accomplished in a number of ways. First, a thief can capture each page of the text as it is displayed, and save all the pages as a multi-page graphics file. However, the resulting file is likely to be large, because usually graphics files are larger than text files, such as ASCII files or word processing files.

Therefore, the thief may convert the captured text pages to a non-graphical format by performing optical character recognition (OCR). OCR is a process by which graphical representations of text are analyzed and converted to non-graphical representations. For example, a computer interprets a graphical representation of a word as an image or graphics file. However, once OCR has been performed, the computer stores the word as its individual constituent letters, in a non-graphical manner. This allows the thief to store a highly compact version of a desired text, such as an ASCII file, a word processing file, and so on.

OCR programs are widely available for a reasonable cost, which heightens the fears of publishers. The accuracy of such program is typically well over 99%. Furthermore, OCR programs usually are used to convert scanned-in paper documents to word processing files, and other non-graphical representations of text. Scanned-in paper documents often are difficult for the OCR programs to convert, because of the blemishes and other extraneous marks that may result from the scanning process. By comparison, pages of an electronic book that are captured as image files have no such marks that may affect the conversion process. This means that OCR programs are likely to have even better accuracy for captured image files than they do for scanned-in pages, worrying publishers even more.

Similarly, when a computer captures the video output from a television, VCR or similar analog device, the captured signal may include extraneous artifacts or noise. Moreover, analog video capturing can also be time consuming because the video has to be played back in order to be captured. However, when videos are received in electronic form, they can often be copied very quickly and without artifacts or noise. Accordingly, electronic videos are susceptible to theft.

For this and other reasons, therefore, there is a need for the present invention.

### SUMMARY OF THE INVENTION

One aspect of this invention relates generally to the graphical display of text, and more particularly to rendering the graphical display of text such that it is resistant to optical character recognition into a non-graphical representation of the text. An aspect of the invention also relates generally to the display of graphical content, such as videos or images, and more particularly to such display with an overlay to render the display theft-resistant.

Another aspect of the invention relates to graphically displaying text in a manner that is resistant to optical character recognition (OCR). Along with the text being displayed graphically, an OCR-resistant element is displayed substantially coincidental with the text. The OCR-resistant element inhibits OCR of the graphically displayed text into a non-graphical representation of the text. The OCR-resistant element may be, for example, a graphical foreground or background displayed under or over the text being graphically displayed. Furthermore, the text itself may be graphically displayed in an anti-aliasing, or dithering, manner, to further impede OCR attempts.

Displaying the OCR-resistant element substantially coincidental with the text renders any captured image file more difficult to convert to a non-graphical representation using OCR. A captured image file would include both the graphical display of text, as well as the OCR-resistant element. Because the OCR-resistant element is displayed substantially coincidental with the text, at least a part of the text lies against the element. OCR programs, therefore, would have difficulty correctly discerning the text from the OCR-resistant element. The resulting non-graphical representation of the text likely would have a significant number of errors, preventing a potential thief from stealing the text.

A further aspect of the invention relates to displaying graphical content, such as video, images, and so on, in a manner that renders the display theft-resistant. An overlay is placed on the graphical content that contains personal information of the user who initially licensed or purchased the content. This personal information may include the user's name, address, phone number, credit card number, or other personally valuable material, such that the user is deterred from distributing the content. The personal information may be overlaid on, or integrated with, the graphical content in a number of ways. For example, the area on which it appears in the graphical content may be fixed or random. The size, design, and transparency, or alpha value, of the display of the personal information may also be fixed or random. The personal information may appear all the time, or it may appear with less frequency. The graphical content is made more theft-resistant because the user is likely to be deterred from disseminating the information, because of the personal information that is contained in the content.

Another embodiment of the present invention also provides systems and methods for overlaying information on a video.

The present invention further provides a device on which a text can be read by a user and includes a screen displaying at least part of the text graphically and substantially coincidental with an optical character recognition (OCR)-resistant element, the element inhibiting OCR of the text graphically displayed on the screen into a non-graphical representation of the text and one or more controls for navigation within the text by the user.

The OCR-resistant element may be a graphical background upon which at least part of the text is graphically overlaid. The OCR-resistant element may be a graphical foreground graphically overlaid upon at least part of the text graphically displayed on the screen.

Desirably, at least part of the text is displayed graphically on the screen as a bit map, and the OCR-resistant element is displayed substantially coincidental with the text as a bit map.

The non-graphical representation of the text may be an ASCII format.

Preferably, at least one of the one or more controls is a physical control situated within a housing of the device. Also, at least one of the one or more controls may be a virtual control displayed on the screen.

Among other things, the device may comprise a dedicated electronic book device, a general purpose computer or a personal-digital assistant (PDA) device.

At least part of the text may be displayed graphically according to an anti-aliasing technique.

The present invention also provides a method comprising: rendering at least part of the text graphically as a bit map; rendering an optical character recognition (OCR)-resistant element on the bit map, the element inhibiting OCR of the text into a non-graphical representation of the text; and, displaying the bitmap where at least part of the text has been graphically rendered and on which the OCR-resistant element has been rendered on a screen of a device. Preferably, the method is performed by execution of a computer program by a processor from a computer-readable medium.

Another aspect of the invention provides a computer-readable medium having data stored thereon, the data representing a bit map displayed on a screen of a device, the bit map having rendered thereon: a graphical representation of at least part of a text; and an optical character recognition (OCR)-resistant element inhibiting OCR of the graphical representation of at least part of the text into a non-graphical representation of at least part of the text.

Another aspect of the invention provides a method comprising purchasing of graphical content by a user and delivery of the graphical content to the user; upon the user desiring to display the graphical content on a display, adding personally valuable information regarding the user to the graphical content to deter dissemination of the graphical content; and displaying the graphical content on the display, as the personally valuable information has been added thereto.

Preferably, the method includes, prior to adding the personally valuable information to the graphical content, rendering the graphical content. Desirably, the graphical content is one of an image file and a video.

It is also preferable for the personally valuable information to have: a position within the graphical content that is one of fixed and variable; a frequency of display within the graphical content that is modifiable; at least one of a size that is modifiable and a design that is modifiable; a transparency relative to the graphical content that is modifiable; and is at least one of a driver's license number of the user, a social security number of the user, a credit card number of the user, a name of the user, an address of the user, and a telephone number of the user.

The method may be performed by execution of a computer program by a processor from a computer-readable medium.

Another aspect of the invention provides a method including purchasing of graphical content by a user, adding personally valuable information regarding the user to the graphical content to deter dissemination of the graphical content, delivering the graphical content to the user, and upon the user desiring to display the graphical content on a display, displaying the graphical content on the display as the personally valuable information has been added thereto.

A further aspect of the invention relates to displaying graphical content, such as video, images, and so on, in a manner that renders the display theft-resistant. An overlay is placed on the graphical content that contains personal information of the user who initially licensed or purchased the content. This personal information may include the user's name, address, phone number, credit card number, or other personally valuable material, such that the user is deterred from distributing the content. The personal information may be overlaid on, or integrated with, the graphical content in a number of ways. For example, the area on which it appears in the graphical content may be fixed or random. The size, design, and transparency, or alpha value, of the display of the personal information may also be fixed or random. The personal information may appear all the time, or it may appear with less frequency. The graphical content is made more theft-resistant because the user is likely to be deterred from disseminating the information, because of the personal information that is contained in the content.

The invention includes methods, devices, and computer-readable media of varying scope. Other aspects, advantages, and embodiments of the invention, beyond those described in this summary, will become apparent by reading the detailed description that follows, and referencing the drawings.

### BRIEF DESCRIPTION OF THE DRAWINGS

FIG. 1 is a diagram of an example electronic book reader device in conjunction with which the invention may be implemented.

FIG. 2 is a diagram showing how a letter is displayed in a graphical manner by using a bit map.

FIG. 3 is a diagram showing how an OCR-resistant element is displayed substantially coincidental with the graphical display of part of a text.

FIG. 4 is a flowchart of a method according to an embodiment of the invention.

FIG. 5 is a diagram showing the addition of personally valuable information to an image to deter dissemination of the image.

FIG. 6 is a diagram showing the addition of personally valuable information to a video to deter dissemination of the video.

FIGS. 7 and 8 are flowcharts of methods to add personally valuable information to graphical content, such as images or videos.

FIG. 9 is an example of a computerized device, such as a general-purpose computer, in conjunction with which the invention may be implemented.

FIG. 10 is a functional diagram of a system for overlaying information on a video.

FIG. 11 is a diagram showing the addition of personally valuable information to an image to deter dissemination of the image.

### DETAILED DESCRIPTION OF THE PREFERRED EMBODIMENT

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the present invention is defined only by the appended claims.

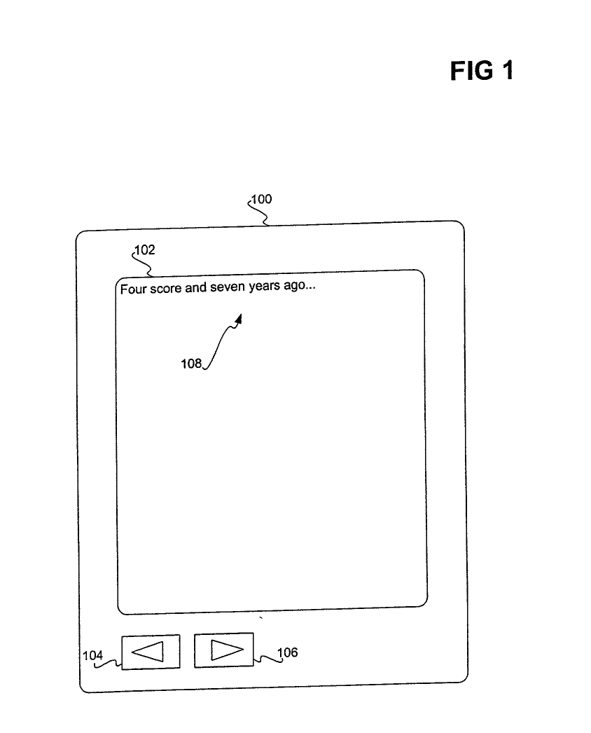

FIG. 1 is a diagram of an example electronic book reader device 100 in conjunction with which the invention may be implemented. The device 100 includes a screen 102, a first navigation control 104, and a second navigation control 106. A part, or page, of a text 108 is graphically displayed on the screen 102. The text 108 can be a book, a magazine, a newspaper, or another type of text. The user actuates the first navigation control 104 to cause the previous page of the text 108 to be graphically displayed on the screen 102. Likewise, the user actuates the second navigation control 106 to cause the next page of the text 108 to be graphically displayed on the screen 102. While the controls 104 and 106 are actual, physical controls situated within the housing of the device 100, alternatively they can be virtual controls displayed on the screen 102, where the screen 102 is a touch-sensitive screen. While only two navigation controls are shown in the diagram of FIG. 1, there can be more navigation controls, too, as well as other types of controls.

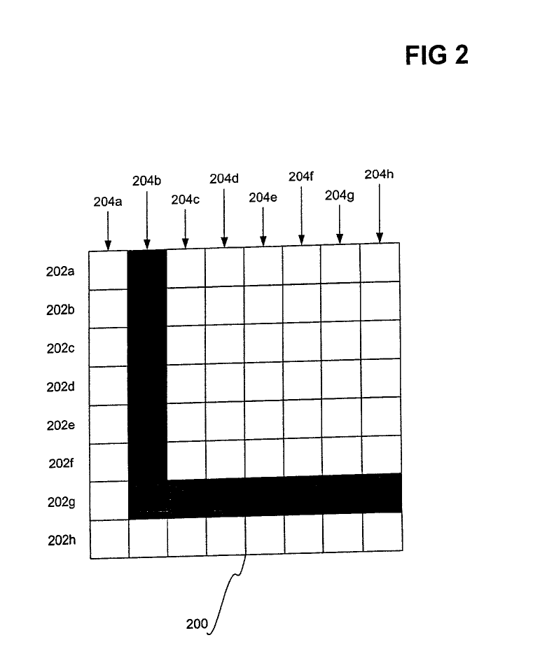

FIG. 2 is a diagram showing how a letter of a word of a text is displayed graphically as a bit map. The grid 200 is divided into a number of pixels, or picture elements. The pixels are organized into eight rows 202a, 202b, 202c, 202d, 202e, 202f, 202g, and 202h, and eight columns 204a, 204b, 204c, 204d, 204e, 204f, 204g, and 204h. Each pixel is identified by a particular column and a particular row. Most of the pixels, such as those identified by the row 202h, are of a background color. However, some of the pixels, such as those identified by the column 204b, except for the pixel within the column 204b that is also identified by the row 202h, are of a foreground color. Pixels are changed to the foreground color to graphically draw a letter. For example, the letter shown in the grid 200 is the capital letter “L.”

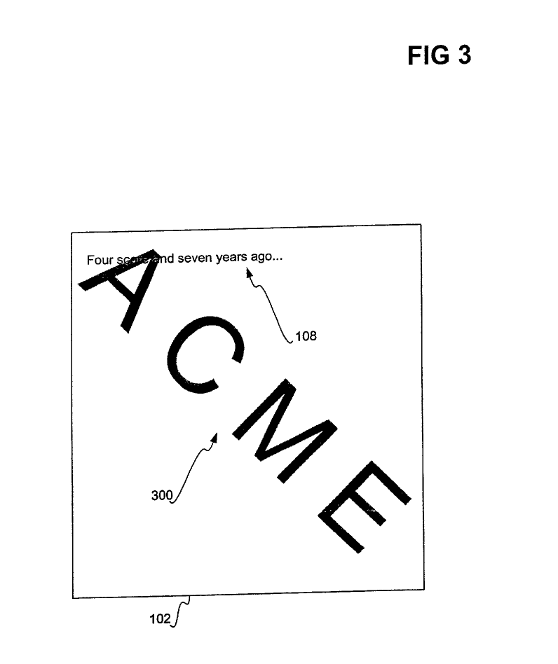

FIG. 3 shows how an OCR-resistant element can be displayed substantially coincidental with the graphical display of text to impair optical character recognition (OCR) of the graphical display of text to a non-graphical representation of text. Besides the part of the text 108 that is displayed graphically on the screen 102, an example OCR-resistant element 300 is also displayed. The OCR-resistant element 300 is preferably displayed at a location and has a size such that it is substantially coincidental with the part of the text 108. That is, at least some of the text 108 displayed graphically on the screen 102 intersects with the OCR-resistant element 300. To ensure readability, the OCR-resistant element 300 may be a different color, or have a different alpha, or transparency, value than the text 108. Preferably, the color of the OCR-resistant element is similar to the color of the text. However, because some of the text 108 intersects with the OCR-resistant element 300, OCR programs will have difficulty discerning the boundaries of text characters, as opposed to the OCR-resistant element 300, increasing errors in the OCR process.

The OCR-resistant element 300 can be a foreground graphic lying on top of the graphical display of the text 108, or a background graphic lying behind the graphical display of the text 108. The element 300 itself can be a graphic or an image of any type. For example, as shown in FIG. 3, the element 300 is the word “ACME,” which may be the manufacturer of the electronic book device, or the publisher of the text 108. The element 300 can also be non-textual, or a combination of non-text and text.

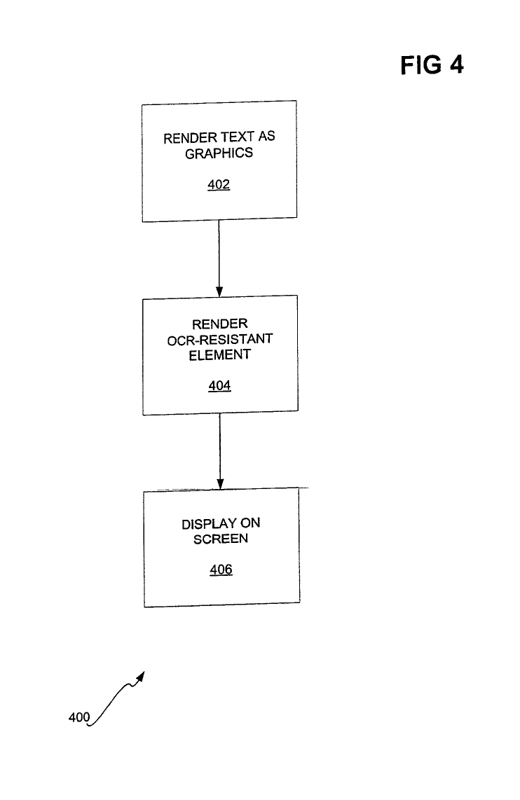

FIG. 4 is a flowchart of a method 400 that one embodiment performs to add the OCR-resistant element 300 to the graphical display of the text 108. First, at least a part of the text 108 is rendered graphically (402), such as a bit map. In particular, data stored on a computer-readable medium represents the bit map. Next, the OCR-resistant element 300 is rendered substantially coincidental on the graphical display of the text 108 (404). This means that at least part of the graphical display of the text 108 intersects at least part of the display of the OCR-resitant element 300. The OCR-resistant element 300, in other words, is added to the bit map represented by the data, such as by blitting the element onto the bit map which has been rendered based on the text. Finally, the rendered graphical display of text 108 and the rendered OCR-resistant element 300 is displayed on the screen 102 (406).

To further impede OCR of the graphical display of the text 108, the text 108 may be graphically displayed according to an anti-aliasing, or dithering, technique in 402, as known within the art. Anti-aliasing generally decreases the clarity of boundaries between foreground and background colors. This means that an OCR program encounters more difficulty discerning the foreground color of the text 108 from the background color on which the text 108 is graphically displayed.

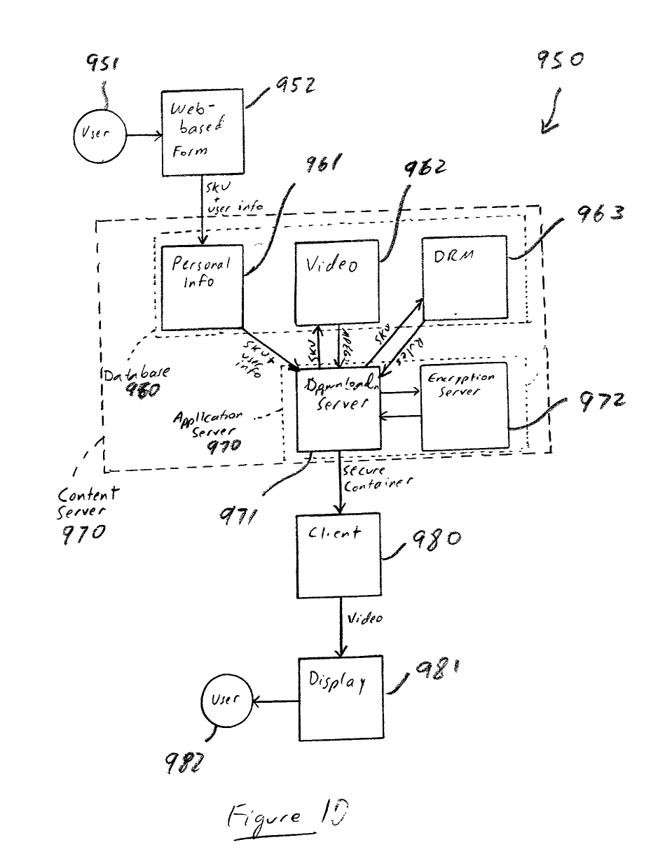

Another aspect of the invention provides systems and methods for overlaying information on a video. Although the system described in FIG. 10 provides an example of how the invention is implemented, it should be understood that the system described in the figure is exemplary only. Various alternatives, processes and components may be used.

The content server 970 includes a database 960 and an application server 970. The database 960 holds the data necessary to provide the video to the client. One manner in which the database may be arranged is to consider it to have three logical units, namely a personal information database 961, a video database 962 and a digital rights management (DRM) database 963.

The video 962 database contains one or more videos. Generally, the videos are stored as 640×480 digital files in a format such as MPEG, AVI or the like. Moreover, the video data is preferably stored in a template in XML format. The template includes not only the data necessary to render the video, but also other information pertaining to the video, such as SKU and bibliographic information. Thus, the XML template for a video called “Movie1” starring John Doe made in 2000 may look as follows:

<Movie>

<Title>

Movie1

</Title>
<Actors>

John Doe

</Actors>
<Year>

2000

</Year>
<File>
wio0sfsfsdf12msf0sdfsdf12lksfd111209sajsadj210sdfsdf485

lks3451sxnsdf0981231jkcs09q3wlkj2141kj0981231jksdlfksdf...

</File>

</Movie>

In the foregoing example, the data which is actually used to store the frames of the video is not in human-readable form but, rather, in the MPEG or AVI format. As with all of the tags, the “file” tag may also point to a file containing the video data rather than actually containing the data itself. (The tag names and data structures have been chosen for clarity of illustration; different names and structures may also be used.)

Application server 970 uses the data from the database 960 to modify or deliver the video to the client. The application server 970 also includes two components, the download server 971 and the encryption server 972.

The download server 971 retrieves and aggregates information from the various databases. The encryption server 972 accepts and encrypts data transferred to it by the download server, returning encrypted data to the download server.

Preferably, the download server and the encryption server are different servers. Optionally, the download server and the encryption server may be logical units within a single computer having a single processor and hard drive. In other words, the instructions and data of the content server may be stored on a single data storage device and implemented by a single processor, or it may be distributed to a number of different storage devices and processors for execution.

The client 980 contains components capable of receiving, processing and displaying data. For example, it may be a personal computer with a modem, CPU and CRT 981. Preferably, the client is a set-top box for a digital television such as the set-top box offered by Scientific Atlanta, Hewlett Packard, Stellar One or Tivo. The set-top box may contain an Ethernet card to communicate with the content server, a processor for processing data, and S-video and RCA jacks for outputting video information to the television. The set top box also includes a memory for storing routines and programs, including decryption software and an XML reader for interpreting the XML document. A remote control allows the user 982 to provide information to the set-top box.

An operation of the invention in accordance with one embodiment may proceed as follows. For the purposes of this example, the content server 970 shall be considered to be a system that is installed in, and provides services to, dwellings within an apartment building or hotel.

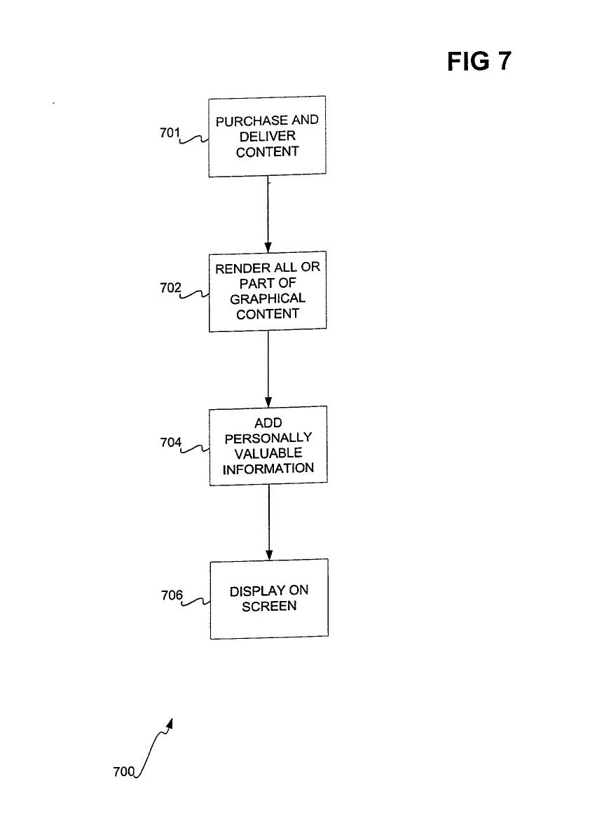

A user 951 first purchases and receives delivery of the graphical content (stop 701 of FIG. 7). For example, a user may request a video by filling out a web-based form 952. The form requires the user 951 to enter their personal information including information which the user would want to keep from the public. Such information shall be hereafter referred to as “private information” or “personally valuable information.”

Preferably, the personally valuable information is known to the user, and is personally valuable to him or her. The information may be a credit card number of the user, such that if the user distributes the graphical content, he or she is also distributing the credit card number, and others can use the number to charge purchases to the user's credit card account, which the user may be responsible for. The information may alternatively be a driver's license number or a social security number, such that the user is deterred from sharing the graphical content with others, because doing so means that the user is at risk for identity theft. That is, others may use the user's personal information to pretend that they are the user to obtain fraudulently obtained credit cards, loans, and so on, for which the user is ostensibly responsible.

The personally valuable information is user known not necessarily in that the user has memorized the information, but it may be that the user has legitimate and legal access to the number. For instance, while a user may not have memorized his or her driver's license number, it is known to the user in that the number is written on his or her driver's license, and is an identification number of the user to which the user has legitimate and legal access. Other types of personally valuable information include the user's name, address, telephone number, and so on.

When the user 951 indicates that they are interested in buying the product, such as by clicking a button on the screen stating “buy”, the user information and the identity of the video are sent to the content server 970. The video may be identified by a SKU.

When the content server 970 receives the SKU and user information from the web-based form 952, it is provided to the download server 971. The download server 971 stores the user's information in the personal information database 961.

The download server 970 also creates an XML document containing: a template retrieved from the video database 962 based on the requested SKU; the user's private information; and rules retrieved from the DRM database 963 based on either the requested SKU, the user information or both. By way of example, an XML file may appear as follows after the video, user and rule information are aggregated together:

<Movie>

<Title>

Movie1

</Title>
<Actors>

John Doe

</Actors>
<Year>

2000

</Year>
<File>
wio0sfsfsdf12msf0sdfsdf121ksfd111209sajsadj210sdfsdf485

lks3451sxnsdf0981231jkcs09q3wlkj2141kj0981231jksdlfksdf...

</File>

</Movie>
<User>

<Name>

Jane Smith

</Name>
<Credit card No >

Visa 1234567890

</Credit card No >
<Social Security No>

123 45 6789

</Social Security No>

</User>
<Rules>

<Number of Plays>

2

</Number of Plays>
<May Be Copied>

No

<May Be Copied>

</Rules>

After the XML document is created, it is provided to the encryption server 972. In order to prevent the fraudulent use of the data, such as counterfeiting of the video data or modifying the rules to expand the user's permitted activities, all or some of the data in the XML document is encrypted. Thus, the exemplary XML document may appear as follows after encryption:

<Movie>

<Title>

Movie1

</Title>
<Actors>

John Doe

</Actors>
<Year>

2000

</Year>
<File>

[encrypted data]

</File>
</Movie>

<User>

<Name>

Jane Smith

</Name>
<Credit card No >

[encrypted data]

</Credit card No >
<Social Security No>

[encrypted data]

</Social Security No>

</User>
<Rules>

<Number of Plays>

[encrypted]

</Number of Plays>
<May Be Copied>

[encrypted]

<May Be Copied>

</Rules>

Rather than encrypting the XML document after it is completely assembled, the encryption server 972 may also work with the download server to encrypt the data as it is added to the XML document. Moreover, some of the data may be encrypted as soon as it is stored in the databases. The video files, for instance, may be stored in the video database in encrypted form.

It is desirable to use the user's private information, such as their credit card number, as the key to encryption. This helps deter theft because people will be reluctant to distribute their private information to others. The encryption of content using a user's private information is discussed in U.S. patent application Ser. No. 09/425,862 filed Oct. 23, 1999, incorporated herein by reference.

Once the XML document is encrypted, it is downloaded to or sent by streaming to the client 980. Preferably, the file name extension reflects the nature of the file so that the client can immediately recognize the file's nature. The foregoing, exemplary XML document thus may be named “Movie1.mmp”, where “mmp” indicates that the file contains information in accordance with the present invention.

Upon arrival to the client, the client 980 decrypts the rules information and ensures that it has authority to play the video. For example, the client will prompt the user for, or obtain from local storage, their credit card information. The credit card information is then used to decrypt the encrypted data.

When the user wishes to display the graphical content on the screen, all or part of the graphical content is first rendered (step 702 of FIG. 7). In the case of an image, the graphical content is rendered all at once, whereas in the case of a video, the graphical content is rendered on a frame-by-frame basis.

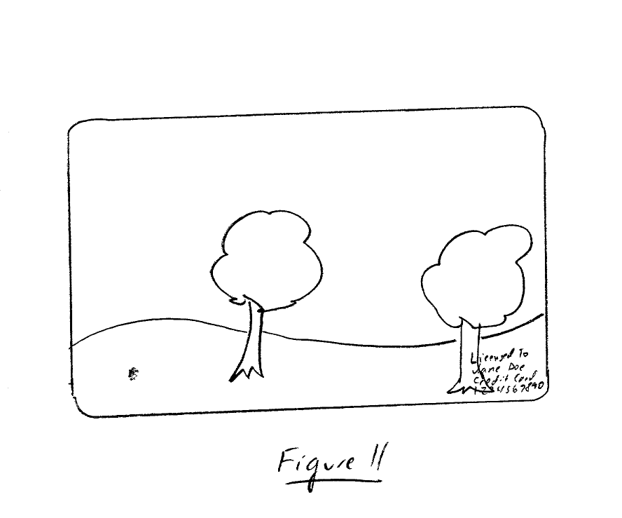

The personally valuable information of the user is then added to the rendered graphical content (step 704), and the rendered graphical content including the personally valuable information is displayed on the screen (step 706). Specifically, during the rendering, the processor within the client appends a graphic overlay to the corner of the video using information stored in the XML document. For example, as shown in FIG. 11, the overlay may display the text “Licensed to Jane Smith, Credit Card 1234567890.”

These overlays, known as “bugs”, are commonly seen on television screens as network logos. However, in the present invention, the bug is not already in the video. Rather, the bug is added to the video at the client using the non-video information contained in the XML document. For example, as shown in FIG. 11, the overlay may display the text “Licensed to Jane Smith, Credit Card 1234567890.” The CPU appends the bug by extracting a frame from the video data and blitting the bug into the bottom right corner of the frame, using a mask to determine which pixels of the bug are copied to the destination frame.

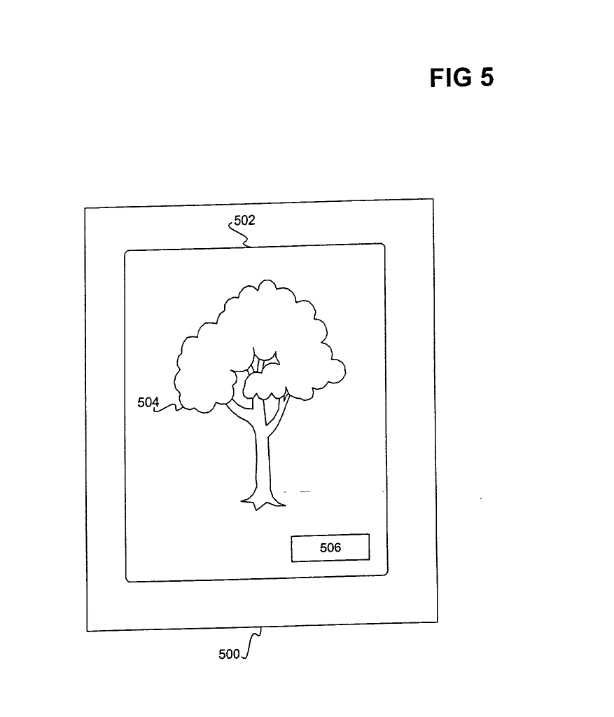

Preferably, the bug displays the user's private information. FIG. 5 provides a diagram of a screen 500 on which an image 502 is being shown. The image 502 is a type of graphical content. The image 502 for example purposes is a tree 504. The image 502 also has overlaid thereon, or integrated thereinto, personally valuable information 506. If the consumer who originally licensed or purchased the image 502 were to unlawfully disseminate the image 502, he or she would also be divulging the personally valuable information 506 contained within the image 502. Likely, however, the consumer does not want to reveal this information 506, and therefore is deterred from disseminating the image 502. As a result, the personally valuable information 506 serves as a deterrent to theft.

By appending the private information to the video, the bug helps deter people from capturing the output of the set-top box and distributing the video in a number of ways. First, it deters unauthorized distribution because many people will be reluctant to provide their personal information to others. Second, it deters unauthorized purchase of the video because many people will not want to play a video which clearly indicates its stolen nature. Third, it deters unauthorized distribution because it makes identifying and tracking the theft much easier. Even if a seller and purchaser were willing to engage in unauthorized activity, the copyright owner can easily find the client which created the original unauthorized copy simply by looking at the private information listed in the bug.

In fact, the invention synergistically uses the user's private information to prevent theft at various levels: at the buying stage to ensure payment, at the encryption stage to secure the content, and as a bug on the screen to deter unauthorized distribution.

The invention advantageously permits a number of options and alternatives. For example, the graphical content may be formatted according to a MPEG file format, a RealVideo file format, a Windows Media file format, a TIF file format, a JPG file format, a GIF file format, or another type of file format.

In addition to providing the information to be displayed by the bug, the XML document may also identify where the bug should be placed on the screen and how large it should be. It may also define the bug's alpha level, i.e., how transparent or opaque the bug should be. The XML document may also indicate how often the bug should appear; examples include showing the bug constantly, periodically, or just at the beginning or end. In fact, the bug may have multiple start and stop times of various durations.

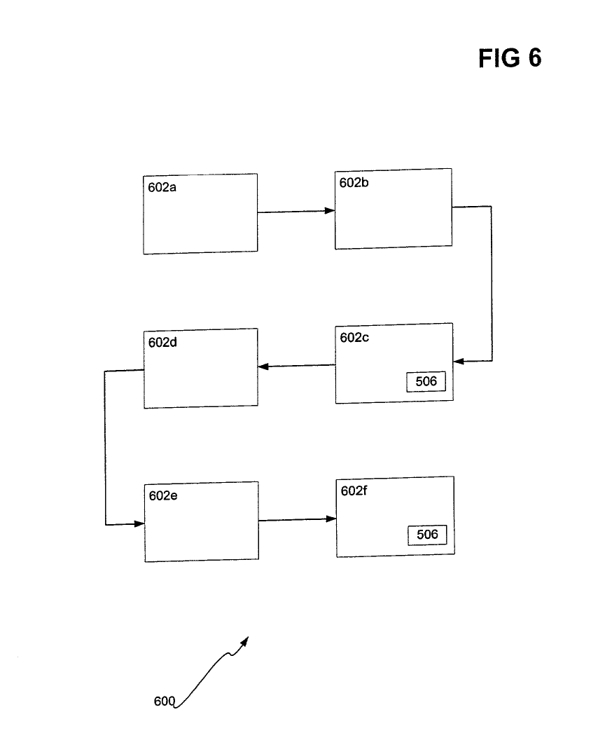

For example, as shown in FIGS. 5 and 6, the personally valuable information 506 has been placed in the lower right-hand corner of the image, or of a frame of the video. In the case of the image of FIG. 5, the information 506 may also be placed in other parts of the image. In the case of the video of FIG. 6, the information 506 may be placed in other parts of the frames as well, and also may appear with more or less frequency in the frames of the video. The information 506 may only be placed in the first frames of the video, for instance. The personally valuable information 506 may also be incorporated into warnings and other notices that typically appear at the beginning of most videos, such as the Federal Bureau of Investigation (FBI) warnings and notices. Again, how frequently the personally valuable information appears within the graphical content, where it appears, and when it appears can be fixed or variable.

The size, design, and transparency of the personally valuable information may also be fixed or variable. For example, the size of the personally valuable information 506 of FIGS. 5 and 6 may be made larger. As another example, in the context of a video, the personally valuable information 506 may be shown screen-size in the first few seconds of frames of the video, and then may appear smaller in the remaining frames of the video. The transparency of the personally valuable information may also be modified to change the extent to which the underlying graphical content can be seen through the personally valuable information. This is typically accomplished by changing the alpha value of the personally valuable information, as known within the art.

FIG. 6 shows a diagram of a video 600 and six frames thereof, 602a, 602b, 602c, 602d, 602e, and 602f. The video 600 is a type of graphical content. The particular content of the video 600 is not shown in FIG. 6 for purposes of clarity. Every three frames of the video 600, however, personally valuable information 506 is overlaid. Thus, the personally valuable information 506 is overlaid on frame 602c, as well as on frame 602f. As with the image of FIG. 5, if the consumer who originally licensed or purchased the video 600 were to unlawfully disseminate the video 600, he or she would also be divulging the personally valuable information 506 contained within the video 600. As a result, the personally valuable information 506 serves as a deterrent to theft.

Moreover, the server may render the bug containing the private information into the video before it is sent to the user. While this has the advantage of ensuring that the bug cannot be separated from the video, it has the disadvantage of increasing the on-the-fly processing requirements of the content server and may not be possible in certain cases, for example where a single video data stream is broadcast to multiple users at a time (as in the case of satellite broadcasts).

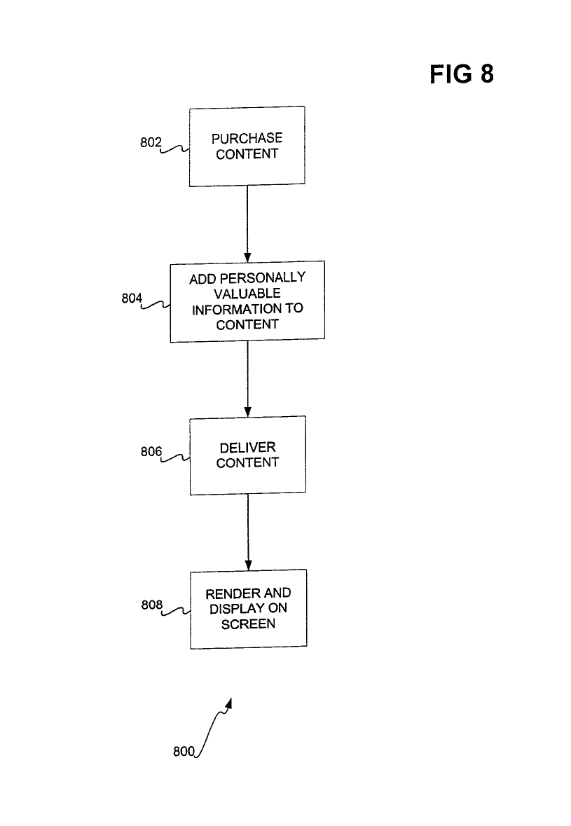

For example, the flowchart of FIG. 8 shows a method 800. A user first purchases graphical content (802). Prior to delivery of the content to the user (806), personally valuable information is added to the content (804). The graphical content, including the personally valuable information is rendered, and displayed on the screen (808).

The difference between the methods 700 and 800 is where the addition of personally valuable information to the graphical content occurs. The addition of personally valuable information means overlaying onto, integrating with, or otherwise adding the personally valuable information to the graphical content. In the method 700 of FIG. 7, the user first receives delivery of the content, and the addition of the personally valuable information thereto is performed at the user's computer. The method 700 has the advantage of not requiring the content provider to add the personally valuable information to the graphical content. However, the method 700 may require that the graphical content be stored at the user's computer in such a way that it is inaccessible to the user without the personally valuable information being added.

By comparison, in the method 800 of FIG. 8, the user receives delivery of the graphical content only after the personally valuable information has been added to it. The method 800 is advantageous in that the graphical content may be stored at the user's computer without further precautions as to its access by the user, because the personally valuable information is already contained within the content. However, the method 800 requires that the personally valuable information be performed by the content provider, or otherwise prior to content delivery to the user.

With respect to form 952, the form may actually be an HTML document that was generated and sent from the content server directly to the client. When the user filled out, the information, gets sent back directly to the content server 970. This has the added benefit of keeping the user's information secure because it is not sent over a public network such as the Internet.

If the user has already downloaded videos in the past, it is not necessary for the user to reenter their personal and private information. Rather, the user may simply login with their pre-defined user ID, login name or password or the system may log the user in automatically.

Although the invention is described above in the context of a wire-based, Ethernet, broadband intranet for an apartment building, it may be implemented in any network. Thus, the network may be the Internet or a LAN and the content server a web server or LAN server. The client may be a satellite set-top box or personal video recorder. The client may also be a PDA, phone or car radio that communicates with the content server via wireless system. Rather than using XML, the document containing the media may use any data structure such as HTML, GPRS, WAP or field-based records.

In addition, it is not necessary to send the video and the other information as a single XML document. Rather, the information can be sent in multiple files at different times.

The XML document may also include other media as well. For example, the document may include an electronic book or a song. An advantage of the present invention is that the data structure of the information relating to the book or song is stored in the XML document in a manner similar to the video. By way of example, a book and song may be represented as follows:

<Book>

<Title>

Book1

</Title>
<Author>

John Doe

</Author>
<Year>

2000

</Year>
<File>

[data]

</File>

</Book>
<Song>

<Title>

Song1

</Title>
<Author>

John Doe

</Author>
<Year>

2000

</Year>
<File>

[data]

</File>

</Song>

The common data structure simplifies processing at the client end because many of the same routines can be used regardless of whether the media is text, video or audio.

By storing multiple medias in the same file with common data structures, and then encrypting some of the information but not others, an entire secure container of may be created. For example, a children's book can be represented by a single file and include text, children's songs and some animation.

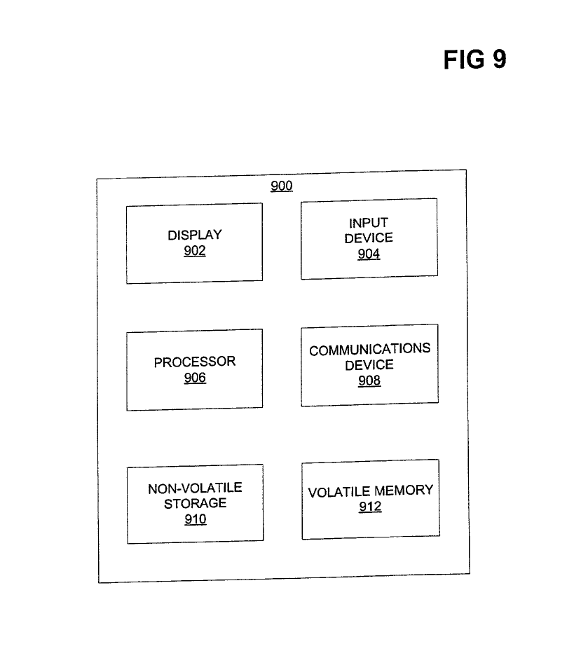

The invention may also be implemented within a computerized environment having one or more computerized devices. The diagram of FIG. 9 shows an example computerized device 900. The example computerized device 900 can be, for example, a desktop computer, a laptop computer, or a personal digital assistant (PDA). The invention may be practiced with other computer system configurations as well, including multiprocessor systems, microprocessor-based or programmable consumer electronics, network computers, minicomputers, and mainframe computers. The invention may be practiced in distributed computing environments where tasks are performed by remote processing devices that are linked through a communications network.

The device 900 includes one or more of the following components: processor(s) 902, memory 904, storage 906, a communications component 908, input device(s) 910, a display 104, and output device(s) 914. For a particular instantiation of the device 900, one or more of these components may not be present. For example, a PDA may not have any output device(s) 914. The description of the device 900 is to be used as an overview of the types of components that typically reside within such a device, and is not meant as a limiting or exhaustive description.

The processor(s) 902 may include a single central-processing unit (CPU), or a plurality of processing units, commonly referred to as a parallel processing environment. The memory 904 may include read-only memory (ROM) and/or random-access memory (RAM). The storage 906 may be any type of storage, such as fixed-media storage devices and removable-media storage devices. Examples of the former include hard disk drives, and flash or other non-volatile memory. Examples of the latter include tape drives, optical drives like CD-ROM drives, and floppy disk drives. The storage devices and their associated computer-readable media provide non-volatile storage of computer-readable instructions, data structures, program modules, and other data. Any type of computer-readable media that can store data and that is accessible by a computer can be used.

The device 900 may operate in a network environment. Examples of networks include the Internet, intranets, extranets, local-area networks (LAN's), and wide-area networks (WAN's). The device 900 may include a communications component 908, which can be present in or attached to the device 900. The component 908 may be one or more of a network card, an Ethernet card, an analog modem, a cable modem, a digital subscriber loop (DSL) modem, and an Integrated Services Digital Network (ISDN) adapter. The input device(s) 910 are the mechanisms by which a user provides input to the device 900. Such device(s) 910 can include keyboards, pointing devices, microphones, joysticks, game pads, and scanners. The display 904 is how the device 900 typically shows output to the user. The display 904 can include cathode-ray tube (CRT) display devices and flat-panel display (FPD) display devices. The device 900 may provide output to the user via other output device(s) 914. The output device(s) 914 can include speakers, printers, and other types of devices.

The methods that have been described can be computer-implemented on the device 900. A computer-implemented method is desirably realized at least in part as one or more programs running on a computer. The programs can be executed from a computer-readable medium such as a memory by a processor of a computer. The programs are desirably storable on a machine-readable medium, such as a floppy disk or a CD-ROM, for distribution and installation and execution on another computer. The program or programs can be a part of a computer system, a computer, or a computerized device.

Unless stated to the contrary, use of the words such as “including,” “containing,” “comprising” and the like, means “including without limitation” and shall not be construed to limit any general statement that it follows to the specific or similar items or matters immediately following it.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims.

1. A method of displaying a semi-transparent graphical overlay in the corner of a video comprising:
retrieving a user's credit card information and an electronic video file containing data representative of frames in a video,
combining the data contained in the electronic video file with the credit card information to create a new file, the new file separating the video data from the credit card information, the credit card information being stored in textual form,
encrypting at least the video data,
sending the new file from a server to a client,
decrypting, at the client, the video data stored in the new file,
rendering, at the client, the video from the video data stored in the new file, the step of rendering including placing a semi-transparent image in the corner of the video whereby the image displays the credit card information,
displaying the rendered video including the semi-transparent image.

2. A method of displaying a video comprising:
encrypting video signals based on first personal information relating to a user,
sending the encrypted video signals with second personal information over a network,
decrypting the video signals based on the first personal information,
rendering the video from the video signals such that the second personal information is overlaid on the video.

3. The method of claim 2 wherein the first and second personal information relate to the same user.

4. The method of claim 3 wherein the second personal information relates to the user's name.

5. The method of claim 1 wherein the first or second personal information relates to the user's credit card number.
